(19) United States
(12) Patent Application Publication
(10) Pub. No.: US 2018/0204450 A1
(43) Pub. Date: Jul. 19, 2018

(54) Method And Apparatus for Controlling Passing of Vehicle At Traffic Intersection

(71) Applicant: HUAWEI TECHNOLOGIES CO., LTD., Shenzhen (CN)

(72) Inventors: Yonggang SONG, Beijing (CN); Hui LI, Shenzhen (CN)

(21) Appl. No.: 15/922,568

(22) Filed: Mar. 15, 2018

Related U.S. Application Data
(63) Continuation of application No. PCT/CN2015/089702, filed on Sep. 16, 2015.

(51) Int. Cl. G08G 1/01; G08G 1/16; G08G 1/09; G08G 1/095

(52) U.S. Cl. CPC G08G 1/0145; G08G 1/164; G08G 1/095; G08G 1/093; G08G 1/166

(57) ABSTRACT

A method for controlling passing of a vehicle at a traffic intersection is provided. The method includes: obtaining passing priority information of each waiting vehicle flow in a waiting vehicle flow set in real time according to a current road condition, and the passing priority information indicates a priority of a vehicle flow in passing through the traffic intersection; determining a waiting vehicle flow of a highest priority in the waiting vehicle flow set as a first vehicle flow; determining a target vehicle flow set according to the first vehicle flow and prestored collision relationship information; and instructing a vehicle flow in the target vehicle flow set to pass through the traffic intersection. The target vehicle flow set includes the first vehicle flow. Any two vehicle flows in the target vehicle flow set do not collide with each other.

### CROSS-REFERENCE TO RELATED APPLICATIONS

This application is a continuation of International Application No. PCT/CN2015/089702, filed on Sep. 16, 2015, the disclosure of which is hereby incorporated by reference in its entirety.

### TECHNICAL FIELD

Embodiments of the present invention relate to the traffic control field, and more specifically, to a method and an apparatus for controlling passing of a vehicle at a traffic intersection.

### BACKGROUND

To ease traffic and improve passing efficiency at a traffic intersection, in the prior art, a running cycle of traffic lights is usually set according to a historical traffic condition at the traffic intersection, so as to control passing of a vehicle at the traffic intersection. However, a traffic condition at a traffic intersection cannot remain unchanged in a long term. Once the traffic condition changes, a running cycle of traffic lights may be no longer suitable for a current traffic condition, and consequently, passing efficiency at the traffic intersection is reduced.

### SUMMARY

Embodiments of the present invention provide a method and an apparatus for controlling passing of a vehicle at a traffic intersection, to improve passing efficiency at the traffic intersection.

According to first aspect, a method for controlling passing of a vehicle at a traffic intersection is provided, including: obtaining passing priority information of each waiting vehicle flow in a waiting vehicle flow set in real time according to a current road condition, where the waiting vehicle flow is a set of vehicles that are waiting on a preset route to pass through the traffic intersection, and the passing priority information is used to indicate a priority of a vehicle flow in passing through the traffic intersection; determining a waiting vehicle flow of a highest priority in the waiting vehicle flow set as a first vehicle flow according to the passing priority information; determining a target vehicle flow set according to the first vehicle flow and prestored collision relationship information, where the target vehicle flow set includes the first vehicle flow, any two vehicle flows in the target vehicle flow set do not collide with each other, and the collision relationship information is used to indicate whether there is a collision when different vehicle flows simultaneously pass through the traffic intersection; and instructing a vehicle flow in the target vehicle flow set to pass through the traffic intersection.

With reference to the first aspect, in a first implementation of the first aspect, the determining a target vehicle flow set according to the first vehicle flow and prestored collision relationship information includes: determining at least one vehicle flow in the target vehicle flow set according to the collision relationship information and a priority of the waiting vehicle flow, where the at least one vehicle flow includes a vehicle flow of a highest priority in vehicle flows that do not collide with the first vehicle flow.

With reference to either the first aspect or the foregoing implementation of the first aspect, in another implementation of the first aspect, the determining a target vehicle flow set according to the first vehicle flow and prestored collision relationship information includes: determining, according to the collision relationship information, whether a waiting vehicle flow that does not collide with any vehicle flow in the target vehicle flow set exists in the waiting vehicle flow set, and when the waiting vehicle flow that does not collide with any vehicle flow in the target vehicle flow set exists in the waiting vehicle flow set, selecting a waiting vehicle flow of a highest priority from the waiting vehicle flow and adding the selected waiting vehicle flow to the target vehicle flow set, and repeatedly performing this step, or when no waiting vehicle flow that does not collide with any vehicle flow in the target vehicle flow set exists in the waiting vehicle flow set, quitting iteration.

With reference to any one of the first aspect or the foregoing implementations of the first aspect, in another implementation of the first aspect, the method further includes: obtaining an integral table, where an integral in the integral table is used to represent the passing priority information.

With reference to any one of the first aspect or the foregoing implementations of the first aspect, in another implementation of the first aspect, the obtaining passing priority information of a waiting vehicle flow according to a current road condition includes: determining the passing priority information of the waiting vehicle flow according to at least one of a vehicle flow length, a vehicle type, or a vehicle flow waiting time.

With reference to any one of the first aspect or the foregoing implementations of the first aspect, in another implementation of the first aspect, the method further includes: after the at least one vehicle flow in the target vehicle flow set passes through the traffic intersection, selecting a vehicle flow from the waiting vehicle flow set according to the passing priority information and the collision relationship information, and adding the selected vehicle flow to the target vehicle flow set to form a new target vehicle flow set, where any two vehicle flows in the new target vehicle flow set do not collide with each other.

With reference to any one of the first aspect or the foregoing implementations of the first aspect, in another implementation of the first aspect, a vehicle in each waiting vehicle flow in the waiting vehicle flow set is an unmanned vehicle, and the obtaining passing priority information of each waiting vehicle flow in a waiting vehicle flow set in real time according to a current road condition includes: obtaining the passing priority information of each waiting vehicle flow in the waiting vehicle flow set in real time according to a current road condition that is obtained from a network.

According to second aspect, an apparatus for controlling passing of a vehicle at a traffic intersection is provided, including: an obtaining module, configured to obtain passing priority information of each waiting vehicle flow in a waiting vehicle flow set in real time according to a current road condition, where the waiting vehicle flow is a set of vehicles that are waiting on a preset route to pass through the traffic intersection, and the passing priority information is used to indicate a priority of a vehicle flow in passing through the traffic intersection; a first determining module, configured to determine a waiting vehicle flow of a highest priority in the waiting vehicle flow set as a first vehicle flow according to the passing priority information; a second determining module, configured to determine a target vehicle flow set according to the first vehicle flow and prestored collision relationship information, where the target vehicle flow set includes the first vehicle flow, any two vehicle flows in the target vehicle flow set do not collide with each other, and the collision relationship information is used to indicate whether there is a collision when different vehicle flows simultaneously pass through the traffic intersection; and an instruction module, configured to instruct a vehicle flow in the target vehicle flow set to pass through the traffic intersection.

With reference to the second aspect, in a first implementation of the second aspect, the first determining module is specifically configured to determine at least one vehicle flow in the target vehicle flow set according to the collision relationship information and a priority of the waiting vehicle flow, where the at least one vehicle flow includes a vehicle flow of a highest priority in vehicle flows that do not collide with the first vehicle flow.

With reference to either the second aspect or the foregoing implementation of the second aspect, in another implementation of the second aspect, the first determining module is specifically configured to: determine, according to the collision relationship information, whether a waiting vehicle flow that does not collide with any vehicle flow in the target vehicle flow set exists in the waiting vehicle flow set, and when the waiting vehicle flow that does not collide with any vehicle flow in the target vehicle flow set exists in the waiting vehicle flow set, select a vehicle flow of a highest priority from the waiting vehicle flow and add the selected vehicle flow to the target vehicle flow set, and repeatedly perform this step, or when no waiting vehicle flow that does not collide with any vehicle flow in the target vehicle flow set exists in the waiting vehicle flow set, quit iteration.

With reference to any one of the second aspect or the foregoing implementations of the second aspect, in another implementation of the second aspect, the obtaining module is further configured to obtain an integral table, where an integral in the integral table is used to represent the passing priority information.

With reference to any one of the second aspect or the foregoing implementations of the second aspect, in another implementation of the second aspect, the obtaining module is further configured to determine the passing priority information of the waiting vehicle flow according to at least one of a vehicle flow length, a vehicle type, or a vehicle flow waiting time.

With reference to any one of the second aspect or the foregoing implementations of the second aspect, in another implementation of the second aspect, the apparatus further includes: a third determining module, configured to: after the at least one vehicle flow in the target vehicle flow set passes through the traffic intersection, select a vehicle flow from the waiting vehicle flow set according to the passing priority information and the collision relationship information, and add the selected vehicle flow to the target vehicle flow set.

With reference to any one of the second aspect or the foregoing implementations of the second aspect, in another implementation of the second aspect, a vehicle in each waiting vehicle flow in the waiting vehicle flow set is an unmanned vehicle, and the obtaining module is specifically configured to obtain the passing priority information of each waiting vehicle flow in the waiting vehicle flow set in real time according to a current road condition that is obtained from a network.

In the embodiments of the present invention, a priority of each vehicle flow is considered, so that a vehicle flow of a relatively high priority can preferentially pass through a traffic intersection. In addition, a collision relationship between vehicle flows is further considered, so that vehicle flows that do not collide with each other can simultaneously pass through the traffic intersection. That is, in the embodiments of the present invention, a target vehicle flow set that passes through the traffic intersection is determined in real time by considering both the priority of the vehicle flow and the collision relationship. By contrast, in the prior art, a vehicle flow that preferentially passes through the traffic intersection is determined only according to historical traffic condition information. Therefore, vehicle flows can be alternated rapidly, and passing efficiency at the traffic intersection is improved.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a schematic diagram of a vehicle flow at a crossroad;

FIG. 2 is a schematic flowchart of a method for controlling passing of a vehicle at a traffic intersection according to an embodiment of the present invention;

FIG. 3 is a schematic flowchart of an apparatus for controlling passing of a vehicle at a traffic intersection according to an embodiment of the present invention; and

FIG. 4 is a schematic flowchart of an apparatus for controlling passing of a vehicle at a traffic intersection according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

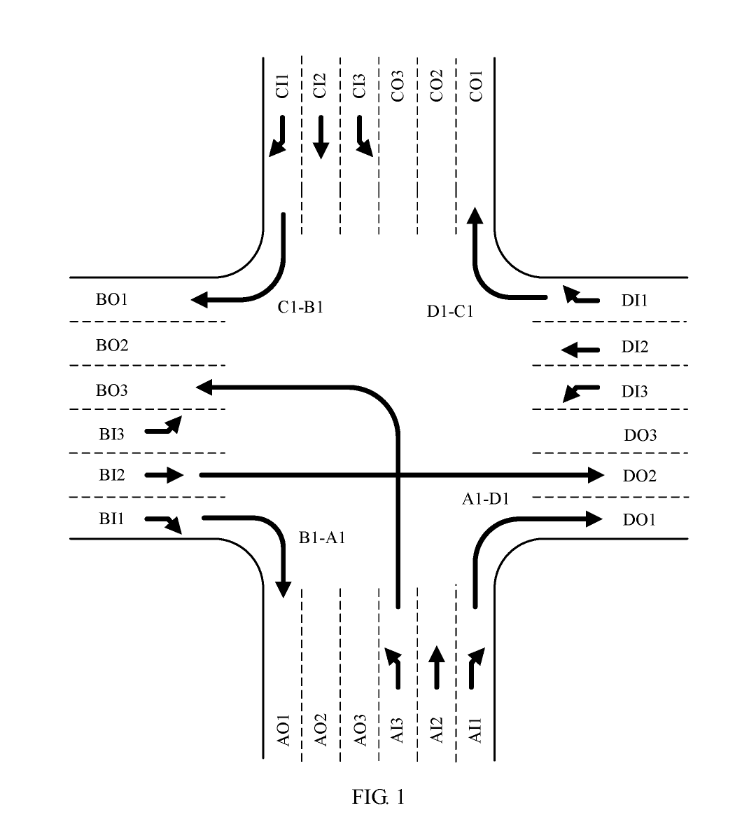

For ease of understanding, a most common crossroad is used as an example herein to briefly describe an application scenario of a method and an apparatus for controlling passing of a vehicle at a traffic intersection in the embodiments of the present invention. A scenario of a crossroad in a typical embodiment is described below with reference to FIG. 1.

(1) All vehicles on a road are standard and controlled unmanned vehicles, and there is no pedestrian or other unexpected interference.

(2) Locations, directions, speeds, and other status information of all vehicles that enter and exit an intersection may be learned by means of network communication.

(3) A design of three lanes in a single way is used for the crossroad. There are separately a left-turn lane, a through lane, and a right-turn lane near an intersection. There is no through and right-turn compound lane or through and left-turn compound lane. Vehicle U-turn is not considered.

(4) A vehicle going straight ahead still enters a through lane in the middle after passing through an intersection, a vehicle turning left enters a left-turn lane on a left side after passing through an intersection, and a vehicle turning right enters a right-turn lane on a right side after passing through an intersection.

(5) As shown in FIG. 1, for ease of understanding, the crossroad is abstracted and defined as follows.

Road number: The crossroad is used as a center, and four roads in 6 o'clock, 9 o'clock, 12 o'clock, and 3 o'clock directions are respectively defined as A, B, C, and D.

Lane number: A number of each lane is “road number+enter/exit sign+lane sequence number”. “I” and “O” are signs indicating entering or exiting an intersection, “I” represents entering an intersection, and “O” represents exiting an intersection. Lane sequence numbers are 1, 2, and 3 in sequence from the outside of a road to the inside. For example, AI3 represents turning left to pass through an intersection, AI2 represents going straight ahead to pass through an intersection, and AI1 represents turning right to pass through an intersection.

Vehicle flow number: To simplify expressions and avoid ambiguity, the vehicle flow number does not include an enter/exit sign. For example, “A1-D1” represents a vehicle flow that turns right from AI1 to DO1.

It should be understood that the method for controlling passing of a vehicle at a traffic intersection in the embodiments of the present invention may be applied not only to a crossroad, but also to a T-intersection, a multi-direction intersection, entrances and exits of main and side roads, and another irregular intersection.

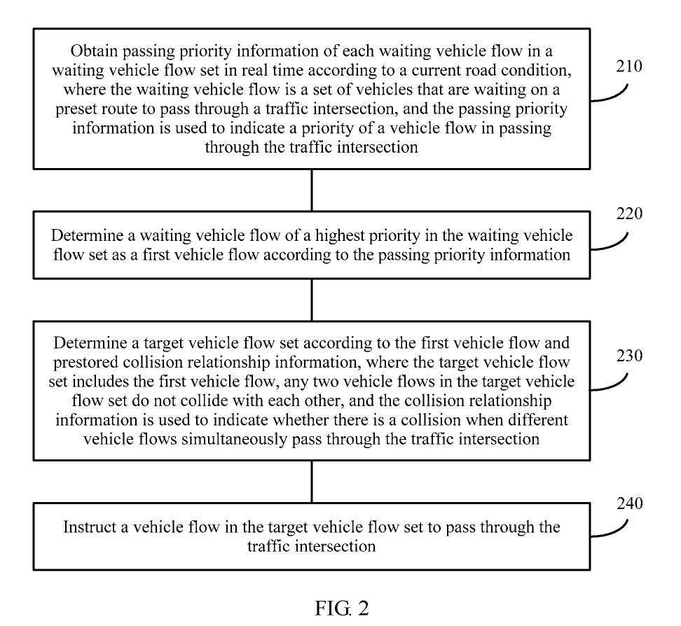

FIG. 2 is a schematic flowchart of a method for controlling passing of a vehicle at a traffic intersection according to an embodiment of the present invention. The method in FIG. 2 may be performed by a traffic control system. As shown in FIG. 2, the method includes the following steps.

210. Obtain passing priority information of each waiting vehicle flow in a waiting vehicle flow set in real time according to a current road condition, where the waiting vehicle flow is a set of vehicles that are waiting on a preset route to pass through the traffic intersection, and the passing priority information is used to indicate a priority of a vehicle flow in passing through the traffic intersection.

It should be understood that the waiting vehicle flow in step 210 may be a set of all vehicles that are waiting in a lane near the traffic intersection at a current moment to pass through the traffic intersection. In this case, the waiting vehicle flow is of a specific vehicle flow length, that is, there is a specific quantity of vehicles in the waiting vehicle flow. In addition, the waiting vehicle flow is in a close relationship with time. At different moments, different vehicle flows are waiting in a same lane to pass through the traffic intersection.

The waiting vehicle flow set may include all vehicle flows that are waiting to pass through the traffic intersection. As shown in FIG. 1, vehicle flows A1-D1, B1-A1, C1-B1, and D1-C1 are respectively vehicle flows that turn right on roads A, B, C, and D to pass through the traffic intersection. Each vehicle flow in these right-turn vehicle flows does not collide with any other vehicle flow. These vehicle flows do not need to wait at the traffic intersection, and can pass through the traffic intersection at any time. Therefore, alternatively, the waiting vehicle flow set may not include these right-turn vehicle flows.

In step 210, the current road condition may be obtained by using a network or a vehicle detector deployed near the traffic intersection. The current road condition may be road condition information such as a vehicle flow length of each waiting vehicle flow at the traffic intersection, a vehicle flow waiting time, and a vehicle type of a vehicle flow. Specifically, the passing priority information may be determined according to at least one of the vehicle flow length, the vehicle type, or the vehicle flow waiting time. It should be understood that the passing priority information may be determined according to factors such as a distance between vehicles in a vehicle flow and whether a vehicle flow is a vehicle flow that is going straight ahead, in addition to the vehicle flow length, a vehicle flow type, or the vehicle flow waiting time. The passing priority information may be represented in multiple forms. For example, the passing priority information may be represented in a form of an integral, or may be represented in a form of an order of vehicle flows, or the like. When the passing priority information is represented in the form of an integral, it may be considered that a larger integral indicates a higher priority of a vehicle flow and indicates that the vehicle flow passes through the traffic intersection more easily. Certainly, it may be agreed that a smaller integral indicates a higher priority of a vehicle flow and indicates that the vehicle flow passes through the traffic intersection more easily.

220. Determine a waiting vehicle flow of a highest priority in the waiting vehicle flow set as a first vehicle flow according to the passing priority information.

In step 220, the first vehicle flow may be determined in multiple manners. For example, when the passing priority information is represented in the form of an integral, a waiting vehicle flow with a greatest integral may be selected from the waiting vehicle flow set as the first vehicle flow, or a waiting vehicle flow with a lowest integral may be selected from the waiting vehicle flow set as the first vehicle flow.

230. Determine a target vehicle flow set according to the first vehicle flow and prestored collision relationship information, where the target vehicle flow set includes the first vehicle flow, any two vehicle flows in the target vehicle flow set do not collide with each other, and the collision relationship information is used to indicate whether there is a collision when different vehicle flows simultaneously pass through the traffic intersection.

It should be understood that a vehicle flow in the target vehicle flow set may include only the first vehicle flow. For example, at a relatively simple traffic intersection, there may be only one vehicle flow in the target vehicle flow set. In this case, because there is only the first vehicle flow, no collision occurs in the vehicle flow in the target vehicle flow set. Certainly, the target vehicle flow set may include, in addition to the first vehicle flow, at least one vehicle flow that is in the waiting vehicle flow set and that does not collide with the first vehicle flow. In this case, at least one vehicle flow may be selected according to a priority from a waiting vehicle flow set that does not collide with the first vehicle flow, and added to the target vehicle flow set, or a vehicle flow of a highest priority may be selected from a waiting vehicle flow set that does not collide with the first vehicle flow, and added to the target vehicle flow set. Certainly, at least one vehicle flow may be randomly selected from a waiting vehicle flow set that does not collide with the first vehicle flow, and added to the target vehicle flow set.

When the passing priority information is represented in the form of an integral, a vehicle flow with a greatest integral may be selected from a waiting vehicle flow set that does not collide with the first vehicle flow, and the vehicle flow is added to the target vehicle flow set. In addition, the target vehicle flow set may be determined according to both the collision relationship information and an integral of a vehicle flow, so that a sum of integrals of all vehicle flows in the target vehicle flow set is as large as possible.

It should be understood that if the waiting vehicle flow set includes the right-turn vehicle flows A1-D1, B1-A1, C1-B1, and D1-C1 at the traffic intersection, when the first vehicle flow and another vehicle flow are selected from a waiting vehicle flow set, the right-turn vehicle flows may not be considered, and the first vehicle flow and the another vehicle flow are selected from the waiting vehicle flow set except the right-turn vehicle flows and added to the target vehicle flow set. It may be directly agreed that the right-turn vehicle flows can pass through the traffic intersection at any time. It should be further understood that the collision relationship information may be determined in advance according to a lane setting situation at the traffic intersection. Generally, if lane setting at the traffic intersection does not change, the collision relationship information does not change either. Therefore, the collision relationship information is relatively fixed, and may be prestored in the traffic control system.

240. Instruct a vehicle flow in the target vehicle flow set to pass through the traffic intersection.

It should be understood that after the vehicle flow in the target vehicle flow set is determined, the vehicle flow may be instructed, by using traffic lights, to pass through the traffic intersection, or the vehicle flow may be guided through the traffic intersection by means of network control and the like.

In addition, after the target vehicle flow set is determined, the target vehicle flow set may be further updated in real time according to the passing priority information. At a current moment, only a vehicle flow in the target vehicle flow set can pass through the traffic intersection, and a vehicle flow that is not in the target vehicle flow set needs to wait at the traffic intersection temporarily. For example, at the current moment, if the target vehicle flow set includes the first vehicle flow, the first vehicle flow can pass through the traffic intersection at the current moment. After a period of time, a road condition changes and the target vehicle flow set no longer includes the first vehicle flow, and therefore, the first vehicle flow needs to wait temporarily and cannot pass through the traffic intersection. It should be understood that a vehicle flow that is not in the target vehicle flow set cannot pass through the traffic intersection temporarily at the current moment, and needs to wait temporarily at the traffic intersection. The vehicle flow can pass through the traffic intersection only after being added to the target vehicle flow set.

In this embodiment of the present invention, a priority of each vehicle flow is considered, so that a vehicle flow of a relatively high priority can preferentially pass through a traffic intersection. In addition, a collision relationship between vehicle flows is further considered, so that vehicle flows that do not collide with each other can simultaneously pass through the traffic intersection. That is, in this embodiment of the present invention, a target vehicle flow set that passes through the traffic intersection is determined in real time by considering both the priority of the vehicle flow and the collision relationship. By contrast, in the prior art, a vehicle flow that preferentially passes through the traffic intersection is determined only according to historical traffic condition information. Therefore, vehicle flows can be alternated rapidly, and passing efficiency at the traffic intersection is improved.

The collision relationship information may be represented by using a collision relationship table or in a form of other data. When the traffic intersection is a traffic intersection shown in FIG. 1, and the collision relationship information is represented by using a collision relationship table, a collision relationship shown in Table 1 may be used to represent a collision relationship between vehicle flows. A collision relationship between any two vehicle flows in all vehicle flows at the traffic intersection is included in Table 1. A symbol * indicates that there is no collision in a same vehicle flow. Y indicates that two vehicle flows collide with each other and cannot simultaneously pass through the traffic intersection. N indicates that two vehicle flows do not collide with each other and can simultaneously pass through the traffic intersection. In addition, there are some special vehicle flows in Table 1. The vehicle flows are vehicle flows that do not collide with any other vehicle flow, for example, A1-D1, B1-A1, C1-B1, and D1-C1, that is, the right-turn vehicle flows shown in FIG. 1. The vehicle flows do not impose any impact on another vehicle flow when passing through the traffic intersection, and can directly pass through the traffic intersection without performing determining. It should be understood that a vehicle collision relationship table shown in Table 1 is corresponding to the crossroad in FIG. 1, and includes a collision relationship between any two vehicle flows in all vehicle flows at the crossroad, and another traffic intersection is corresponding to a different collision relationship table.

TABLE 1
Vehicle collision relationship table

| Vehicle flow | A1-D1 | A2-C2 | A3-B3 | B1-A1 | B2-D2 | B3-C3 | C1-B1 | C2-A2 | C3-D3 | D1-C1 | D2-B2 | D3-A3 |
|---|---|---|---|---|---|---|---|---|---|---|---|---|
| Al-D1 | * | N | N | N | N | N | N | N | N | N | N | N |
| A2-C2 | N | * | N | N | Y | N | N | N | Y | N | Y | Y |
| A3-B3 | N | N | * | N | Y | Y | N | Y | N | N | N | Y |
| B1-Al | N | N | N | * | N | N | N | N | N | N | N | N |
| B2-D2 | N | Y | Y | N | * | N | N | Y | N | N | N | Y |
| B3-C3 | N | N | Y | N | N | * | N | Y | Y | N | Y | N |
| C1-B1 | N | N | N | N | N | N | * | N | N | N | N | N |
| C2-A2 | N | N | Y | N | Y | Y | N | * | N | N | Y | N |
| C3-D3 | N | Y | N | N | N | Y | N | N | * | N | Y | Y |
| D1-C1 | N | N | N | N | N | N | N | N | N | * | N | N |
| D2-B2 | N | Y | N | N | N | Y | N | Y | Y | N | * | N |
| D3-A3 | N | Y | Y | N | Y | N | N | N | Y | N | N | * |

Optionally, in an embodiment, at least one vehicle flow in the target vehicle flow set may be determined according to the collision relationship information and a priority of the waiting vehicle flow, and the at least one vehicle flow includes a vehicle flow of a highest priority in vehicle flows that do not collide with the first vehicle flow.

Specifically, after the first vehicle flow is determined and added to the target vehicle flow set, a vehicle flow of a highest priority may be selected, as a second vehicle flow, from waiting vehicle flows that do not collide with the first vehicle flow, and the second vehicle flow is added to the target vehicle flow set. After the first vehicle flow and the second vehicle flow are added to the target vehicle flow set, one or more vehicle flows may be further selected randomly from waiting vehicle flows that collide with neither the first vehicle flow nor the second vehicle flow, and are added to the target vehicle flow set.

Preferably, after the first vehicle flow is determined and added to the target vehicle flow set, a vehicle flow of a highest priority may be selected, as a second vehicle flow, from waiting vehicle flows that do not collide with the first vehicle flow, and the second vehicle flow is added to the target vehicle flow set. Then, a vehicle flow of a highest priority may be further selected from waiting vehicle flows that collide with neither of the vehicle flows that are already in the target vehicle flow set, and added to the target vehicle flow set. It should be understood that in a process of adding a vehicle flow to the target vehicle flow set, it should be ensured that any two vehicle flows in the target vehicle flow set do not collide with each other.

Optionally, in an embodiment, when the passing priority information is represented in the form of an integral, the target vehicle flow set may be determined by using the following steps: After the first vehicle flow is determined and added to the target vehicle flow set, a vehicle flow with a greatest integral may be selected, as a second vehicle flow, from waiting vehicle flows that do not collide with the first vehicle flow, and the second vehicle flow is added to the target vehicle flow set; and then one or more vehicle flows may be further selected randomly from waiting vehicle flows that collide with neither the first vehicle flow nor the second vehicle flow, and added to the target vehicle flow set.

Preferably, when the passing priority information is represented in the form of an integral, the target vehicle flow set may be determined by using the following steps: After the first vehicle flow is determined and added to the target vehicle flow set, a vehicle flow with a greatest integral may be selected, as a second vehicle flow, from waiting vehicle flows that do not collide with the first vehicle flow, and the second vehicle flow is added to the target vehicle flow set; and then a vehicle flow with a greatest integral may be further selected from waiting vehicle flows that do not collide with neither of the vehicle flows that are already in the target vehicle flow set, and added to the target vehicle flow set. It should be understood that in a process of adding a vehicle flow to the target vehicle flow set, it should be ensured that any two vehicle flows in the target vehicle flow set do not collide with each other.

Optionally, in an embodiment, when the passing priority information is represented in the form of an integral, the target vehicle flow set may be determined by using the following steps: After the first vehicle flow is determined and added to the target vehicle flow set, a vehicle flow may be selected from the waiting vehicle flow set according to the collision relationship information and an integral of a vehicle flow, and added to the target vehicle flow set, so that a sum of integrals of all vehicle flows in the target vehicle flow set is as large as possible.

Optionally, in an embodiment, whether a waiting vehicle flow that does not collide with any vehicle flow in the target vehicle flow set exists in the waiting vehicle flow set may be determined according to the collision relationship information. When the waiting vehicle flow that does not collide with any vehicle flow in the target vehicle flow set exists in the waiting vehicle flow set, a vehicle flow with a greatest integral is selected from the waiting vehicle flow and added to the target vehicle flow set. This step is repeatedly performed. When no waiting vehicle flow that does not collide with any vehicle flow in the target vehicle flow set exists in the waiting vehicle flow set, iteration is quit.

Specifically, a vehicle flow of a highest priority may be selected as a first vehicle flow according to the passing priority information of the waiting vehicle flow, and the first vehicle flow is added to the target vehicle flow set; then a vehicle flow of a highest priority is selected, as a second vehicle flow, from a waiting vehicle flow set that does not collide with the first vehicle flow, and the second vehicle flow is added to the target vehicle flow set; and then a vehicle flow of a highest priority is further selected, as a third vehicle flow, from a waiting vehicle flow set that collides with neither the first vehicle flow nor the second vehicle flow, and the third vehicle flow is added to the target vehicle flow set. This is repeated until the waiting vehicle flow set has no vehicle flow that can be added to the target vehicle flow set.

Optionally, in an embodiment, when the passing priority information is represented in the form of an integral, the target vehicle flow set may be determined by using the following steps: A vehicle flow with a greatest integral may be selected as a first vehicle flow, and the first vehicle flow is added to the target vehicle flow set; then a vehicle flow with a greatest integral is selected, as a second vehicle flow, from a waiting vehicle flow set that does not collide with the first vehicle flow, and the second vehicle flow is added to the target vehicle flow set; and then a vehicle flow with a greatest integral is further selected, as a third vehicle flow, from a waiting vehicle flow set that collides with neither the first vehicle flow nor the second vehicle flow, and the third vehicle flow is added to the target vehicle flow set. This is repeated until the waiting vehicle flow set has no vehicle flow that can be added to the target vehicle flow set.

Optionally, in an embodiment, the passing priority information of each waiting vehicle flow in the waiting vehicle flow set may be obtained by obtaining an integral table, the integral table includes integrals of all waiting vehicle flows, and the integrals may be used to represent the passing priority information. It should be understood that it may be considered that a larger integral in the integral table indicates a higher priority of a vehicle flow and indicates that it is easier for the vehicle flow to pass through the traffic intersection earlier.

Optionally, in an embodiment, an integral of a vehicle flow may be calculated according to a vehicle flow length, a vehicle flow waiting time, and a vehicle type of the vehicle flow, and vehicle flow information obtained in this way is more detailed and accurate. By contrast, in the prior art, a control solution is determined only according to a vehicle flow length. Therefore, utilization of road resources at the traffic intersection is improved, and wastes of the road resources and time resources are reduced. It should be understood that the vehicle flow length herein may be a quantity of vehicles in a vehicle flow, the vehicle flow waiting time may be a time for which the first vehicle in the vehicle flow stops and waits at the traffic intersection, and the vehicle type of the vehicle flow may be vehicle types of all vehicles included in the vehicle flow. For example, the vehicle type may include a bus, a private car, a fire truck, a police car, and another vehicle that executes a special task.

Specifically, an integral of a waiting vehicle flow in each vehicle flow may be calculated according to a formula S=L+T/5+0×A+2×B+100×C. S represents the integral of the waiting vehicle flow. L represents a quantity of vehicles in the vehicle flow. T represents a time for which the first vehicle in the vehicle flow stops and waits at the traffic intersection. A represents a quantity of common vehicles in the vehicle flow. B represents a quantity of public vehicles in the vehicle flow. C represents a quantity of preferential vehicles in the vehicle flow. It should be understood that the common vehicle herein may be a private car, a taxi, or the like. The public vehicle may be a bus, a school bus, or the like. The preferential vehicle may be a vehicle that is executing an urgent task, for example, an ambulance, a police car, and a fire truck.

If the preferential vehicle is not executing an urgent task, the vehicle is regarded as a common vehicle. During integral calculation, an integral of each common vehicle is 0, an integral of each public vehicle is 2, and an integral of each preferential vehicle is 100. In this way, a vehicle of a relatively high priority can pass through the traffic intersection as soon as possible. It should be understood that only a most specific formula for calculating an integral is provided herein. In actual implementation, a specific form of the formula may be further determined by considering both statistical data at the traffic intersection and another factor, or an integral of a vehicle flow may be directly determined in another manner.

Optionally, in an embodiment, after the at least one vehicle flow in the target vehicle flow set passes through the traffic intersection, another vehicle flow may be selected from the waiting vehicle flow set according to the passing priority information and the collision relationship information, and added to the target vehicle flow set to form a new target vehicle flow set. Any two vehicle flows in the new target vehicle flow set do not collide with each other.

Specifically, vehicle flows included in the target vehicle flow set are updated in real time. After a vehicle flow in the target vehicle flow set has completely passed through the traffic intersection, a new vehicle flow may be selected from remaining waiting vehicle flows according to the passing priority information, and added to the target vehicle flow set to form a new target vehicle flow set. It should be understood that after the vehicle flow included in the target vehicle flow set is determined, a specific time may be provided, so that the vehicle flow in the target vehicle flow set passes through the traffic intersection. For example, if the target vehicle flow set totally includes a vehicle flow A, a vehicle flow B, and a vehicle flow C currently, a specific time may be provided to ensure that the vehicle flow A, the vehicle flow B, and the vehicle flow C can completely pass through the traffic intersection. It is assumed that after a period of time, the vehicle flow A has completely passed through the traffic intersection, but the vehicle flow B and the vehicle flow C have not completely passed through the traffic intersection. In this case, a new vehicle flow D that does not collide with a vehicle flow that is already in the target vehicle flow set may be added to the target vehicle flow set, and the new vehicle flow can be added before both the vehicle flow B and the vehicle flow C completely pass through the traffic intersection. In this way, traffic efficiency can be greatly improved particularly in an unmanned scenario, and vehicle flows can be alternated rapidly and seamlessly, so as to achieve best passing efficiency.

Optionally, in an embodiment, when a vehicle in each waiting vehicle flow in the waiting vehicle flow set is an unmanned vehicle, the passing priority information of each waiting vehicle flow in the waiting vehicle flow set may be obtained in real time according to a road condition that is obtained from a network. Specifically, when a vehicle in a vehicle flow is an unmanned vehicle, complete and accurate information about the unmanned vehicle may be accurately obtained from the network in real time. For example, information, such as a location, a direction, a speed, and a vehicle type, about the unmanned vehicle may be obtained from the network in real time. Because information obtained from the network is relatively accurate, a vehicle at the traffic intersection can be controlled precisely, and passing efficiency at the traffic intersection can be improved.

In addition, all vehicles in a vehicle flow may be human-operated vehicles, or some are human-operated vehicles and some are unmanned vehicles. In this case, information about the unmanned vehicle may be accurately obtained from a network in real time. For the human-operated vehicle, related information of the human-operated vehicle may be obtained by adding a network apparatus to the vehicle. Alternatively, when accurate and abundant road condition information cannot be obtained from a network, information, such as a location, a direction, and a speed, about the human-operated vehicle may be obtained by using a vehicle detector (which includes various detection apparatuses such as a camera and a pre-buried coil) deployed at the traffic intersection.

Table 2 shows integrals of vehicle flows at the crossroad shown in FIG. 1. Different integrals represent different priorities of vehicle flows. In Table 2, A1-D1, B1-A1, C1-B1, and D1-C1 are right-turn vehicle flows that do not collide with any other vehicle flow in a traffic road condition. The right-turn vehicle flows can pass through a specific intersection at any time. Therefore, the right-turn vehicle flows have a highest priority and infinitely large integrals. It should be understood that the waiting vehicle flow set in this embodiment of the present invention may not include the vehicle flows that have infinitely large integrals. Table 2 shows only an integral of a vehicle flow at a crossroad, and a traffic road condition in another form may be corresponding to a different integral table.

TABLE 2
Vehicle integral table

| Vehicle | Whether | Vehicle | Waiting | Vehicle | |
|---|---|---|---|---|---|
| flow | collide | flow length | time | type | Integral |
| A1-D1 | N | — | — | — | ∞ |
| A2-C2 | Y | 8 | 25 | 1C | 113 |
| A3-B3 | Y | 3 | 25 | *A | 8 |
| B1-A1 | N | — | — | — | ∞ |
| B2-D2 | Y | 5 | 16 | *A | 8 |
| B3-C3 | Y | 5 | 50 | 1B | 17 |
| C1-B1 | N | — | — | — | ∞ |
| C2-A2 | Y | 6 | 5 | *A | 7 |
| C3-D3 | Y | 3 | 20 | 1B | 9 |
| D1-C1 | N | — | — | — | ∞ |
| D2-B2 | Y | 8 | 20 | *A | 12 |
| D3-A3 | Y | 8 | 16 | *A | 11 |

Optionally, the crossroad in FIG. 1 is used as an example below to specifically describe the method for controlling passing of a vehicle at a traffic intersection in this embodiment of the present invention with reference to Table 1 and Table 2. Specific steps of the method are as follows:

Step 1: A vehicle flow that does not collide with any other vehicle flow passes through the traffic intersection at any time. For example, the four right-turn vehicle flows A1-D1, B1-A1, C1-B1, and D1-C1 in FIG. 1 can pass through the traffic intersection at any time.

Step 2: Select, as a first vehicle flow, a waiting vehicle flow with a greatest integral from a waiting vehicle flow set that is waiting to pass through the traffic intersection. For example, a vehicle flow A2-C2 with a greatest integral in Table 2 may be selected as the first vehicle flow, and then the first vehicle flow is added to a target vehicle flow set.

Step 3: Select, as a second vehicle flow, a vehicle flow with a greatest integral from a waiting vehicle flow set that does not collide with the first vehicle flow. For example, a vehicle flow B3-C3 with a greatest integral may be selected from vehicle flows A3-B3, B3-C3, and C2-A2 in Table 2 as the second vehicle flow, and the second vehicle flow is added to the target vehicle flow set.

After step 2 and step 3, it may be determined that the target vehicle flow set includes only the first vehicle flow and the second vehicle flow. Another vehicle flow in the waiting vehicle flow set cannot pass through the traffic intersection temporarily at a current moment. Specifically, the vehicle flow A2-C2 and the vehicle flow B3-C3 can pass through the traffic intersection, but vehicle flows A3-B3, B2-D2, C2-A2, C3-D3, D2-B2, and D3-A3 cannot pass through the traffic intersection temporarily.

It should be understood that the foregoing steps are completed instantaneously. At the current moment, only a vehicle flow in the target vehicle flow set can pass through the traffic intersection, and remaining vehicle flows in the waiting vehicle flow set need to stop and wait at the intersection temporarily. An integral of a waiting vehicle flow dynamically changes with time. In this case, a vehicle flow that can pass through the traffic intersection and a vehicle flow that cannot pass through the traffic intersection may be determined in real time according to a dynamic change situation of the integral. For example, if the first vehicle flow is currently passing through the traffic intersection, but an integral of the first vehicle flow suddenly declines at a next moment, a vehicle flow that is allowed to pass through the traffic intersection may be reselected from the waiting vehicle flow set, and the first vehicle flow needs to temporarily stop passing through the traffic intersection.

It should be further understood that vehicle flows included in the target vehicle flow set are updated in real time. After a vehicle flow in the target vehicle flow set has completely passed through the traffic intersection, a new vehicle flow may be selected from remaining waiting vehicle flows according to the passing priority information, and added to the target vehicle flow set to form a new target vehicle flow set. In addition, after a vehicle flow included in the target vehicle flow set is determined, a specific time may be provided, so that the vehicle flow in the target vehicle flow set passes through the traffic intersection. For example, if the target vehicle flow set includes a vehicle flow A, a vehicle flow B, and a vehicle flow C at a current moment, a specific time may be provided to ensure that the vehicle flow A, the vehicle flow B, and the vehicle flow C can completely pass through the traffic intersection. It is assumed that after a period of time, the vehicle flow A has completely passed through the traffic intersection, but the vehicle flow B and the vehicle flow C have not completely passed through the traffic intersection. In this case, a new vehicle flow that does not collide with a vehicle flow that is already in the target vehicle flow set may be added to the target vehicle flow set, and the new vehicle flow can be added before both the vehicle flow B and the vehicle flow C completely pass through the traffic intersection.

In addition, in an example for description herein, the crossroad has three lanes in a single way. For another multi-lane case, a vehicle flow that can pass through a traffic intersection and a vehicle flow that cannot pass through the traffic intersection may not be completely determined after step 3 is performed. In this case, step 3 needs to be repeatedly performed until it is completely determined whether all vehicle flows can pass through the traffic intersection.

Optionally, the method for controlling passing of a vehicle at a traffic intersection in this embodiment of the present invention may be further applied to a more complicated lane scenario in which there is a compound lane, vehicle flow convergence, or the like. Specifically, the method may be applied to various intersections with different quantities of lanes such as four lanes and six lanes, and may be further applied to a T-intersection, a multi-direction intersection, entrances and exits of main and side roads, and another irregular intersection.

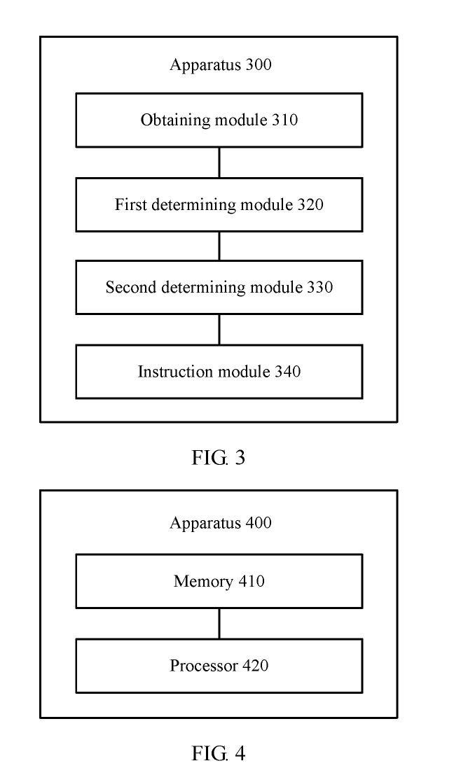

The method for controlling passing of a vehicle at a traffic intersection according to an embodiment of the present invention is described in detail above with reference to FIG. 1 to FIG. 2. An apparatus for controlling passing of a vehicle at a traffic intersection according to an embodiment of the present invention is described in detail below with reference to FIG. 3 to FIG. 4. It should be understood that the apparatus for controlling passing of a vehicle at a traffic intersection described in FIG. 3 and FIG. 4 can implement steps of the method for controlling passing of a vehicle at a traffic intersection described in FIG. 1 to FIG. 2. For brevity, repeated descriptions are appropriately omitted.

FIG. 3 is a schematic flowchart of an apparatus for controlling passing of a vehicle at a traffic intersection according to an embodiment of the present invention.

An apparatus 300 in FIG. 3 includes:
an obtaining module 310, configured to obtain passing priority information of each waiting vehicle flow in a waiting vehicle flow set in real time according to a current road condition, where the waiting vehicle flow is a set of vehicles that are waiting on a preset route to pass through the traffic intersection, and the passing priority information is used to indicate a priority of a vehicle flow in passing through the traffic intersection;
a first determining module 320, configured to determine a waiting vehicle flow of a highest priority in the waiting vehicle flow set as a first vehicle flow according to the passing priority information;
a second determining module 330, configured to determine a target vehicle flow set according to the first vehicle flow and prestored collision relationship information, where the target vehicle flow set includes the first vehicle flow, any two vehicle flows in the target vehicle flow set do not collide with each other, and the collision relationship information is used to indicate whether there is a collision when different vehicle flows simultaneously pass through the traffic intersection; and
an instruction module 340, configured to instruct a vehicle flow in the target vehicle flow set to pass through the traffic intersection.

In this embodiment of the present invention, a priority of each vehicle flow is considered, so that a vehicle flow of a relatively high priority can preferentially pass through a traffic intersection. In addition, a collision relationship between vehicle flows is further considered, so that vehicle flows that do not collide with each other can simultaneously pass through the traffic intersection. That is, in this embodiment of the present invention, a target vehicle flow set that passes through the traffic intersection is determined in real time by considering both the priority of the vehicle flow and the collision relationship. By contrast, in the prior art, a vehicle flow that preferentially passes through the traffic intersection is determined only according to historical traffic condition information. Therefore, vehicle flows can be alternated rapidly, and passing efficiency at the traffic intersection is improved.

Optionally, in an embodiment, the first determining module 320 is specifically configured to determine at least one vehicle flow in the target vehicle flow set according to the collision relationship information and a priority of the waiting vehicle flow, and the at least one vehicle flow includes a vehicle flow of a highest priority in vehicle flows that do not collide with the first vehicle flow.

Optionally, in an embodiment, the first determining module 320 is specifically configured to: determine, according to the collision relationship information, whether a waiting vehicle flow that does not collide with any vehicle flow in the target vehicle flow set exists in the waiting vehicle flow set, and when the waiting vehicle flow that does not collide with any vehicle flow in the target vehicle flow set exists in the waiting vehicle flow set, select a vehicle flow of a highest priority from the waiting vehicle flow and add the selected vehicle flow to the target vehicle flow set, and repeatedly perform this step, or when no waiting vehicle flow that does not collide with any vehicle flow in the target vehicle flow set exists in the waiting vehicle flow set, quit iteration.

Optionally, in an embodiment, the obtaining module 310 is further configured to obtain an integral table, and an integral in the integral table is used to represent the passing priority information.

Optionally, in an embodiment, the obtaining module 310 is further configured to obtain the passing priority information of the waiting vehicle flow according to at least one of a vehicle flow length, a vehicle type, or a vehicle flow waiting time.

Optionally, in an embodiment, the apparatus further includes: a third determining module 350, configured to: after the at least one vehicle flow in the target vehicle flow set passes through the traffic intersection, select a vehicle flow from the waiting vehicle flow set according to the passing priority information and the collision relationship information, and add the selected vehicle flow to the target vehicle flow set.

Optionally, in an embodiment, a vehicle in each waiting vehicle flow in the waiting vehicle flow set is an unmanned vehicle, and the obtaining module 310 is specifically configured to obtain the passing priority information of each waiting vehicle flow in the waiting vehicle flow set in real time according to road condition information that is obtained from a network.

FIG. 4 is a schematic flowchart of an apparatus for controlling passing of a vehicle at a traffic intersection according to an embodiment of the present invention.

An apparatus 400 in FIG. 4 includes:
a memory 410, configured to store a program; and
a processor 420, configured to execute the program, where when the program is executed, the processor 420 is specifically configured to: obtain passing priority information of each waiting vehicle flow in a waiting vehicle flow set in real time according to a current road condition, where the waiting vehicle flow is a set of vehicles that are waiting on a preset route to pass through the traffic intersection, and the passing priority information is used to indicate a priority of a vehicle flow in passing through the traffic intersection; determine a waiting vehicle flow of a highest priority in the waiting vehicle flow set as a first vehicle flow according to the passing priority information; determine a target vehicle flow set according to the first vehicle flow and prestored collision relationship information, where the target vehicle flow set includes the first vehicle flow, any two vehicle flows in the target vehicle flow set do not collide with each other, and the collision relationship information is used to indicate whether there is a collision when different vehicle flows simultaneously pass through the traffic intersection; and instruct a vehicle flow in the target vehicle flow set to pass through the traffic intersection.

In this embodiment of the present invention, a priority of each vehicle flow is considered, so that a vehicle flow of a relatively high priority can preferentially pass through a traffic intersection. In addition, a collision relationship between vehicle flows is further considered, so that vehicle flows that do not collide with each other can simultaneously pass through the traffic intersection. That is, in this embodiment of the present invention, a target vehicle flow set that passes through the traffic intersection is determined in real time by considering both the priority of the vehicle flow and the collision relationship. By contrast, in the prior art, a vehicle flow that preferentially passes through the traffic intersection is determined only according to historical traffic condition information. Therefore, vehicle flows can be alternated rapidly, and passing efficiency at the traffic intersection is improved.

Optionally, in an embodiment, the processor 420 is specifically configured to determine at least one vehicle flow in the target vehicle flow set according to the collision relationship information and a priority of the waiting vehicle flow, and the at least one vehicle flow includes a vehicle flow of a highest priority in vehicle flows that do not collide with the first vehicle flow.

Optionally, in an embodiment, the processor 420 is specifically configured to: determine, according to the collision relationship information, whether a waiting vehicle flow that does not collide with any vehicle flow in the target vehicle flow set exists in the waiting vehicle flow set, and when the waiting vehicle flow that does not collide with any vehicle flow in the target vehicle flow set exists in the waiting vehicle flow set, select a vehicle flow of a highest priority from the waiting vehicle flow and add the selected vehicle flow to the target vehicle flow set, and repeatedly perform this step, or when no waiting vehicle flow that does not collide with any vehicle flow in the target vehicle flow set exists in the waiting vehicle flow set, quit iteration.

Optionally, in an embodiment, the processor 420 is further configured to obtain an integral table, and an integral in the integral table is used to represent the passing priority information.

Optionally, in an embodiment, the processor 420 is further configured to obtain the passing priority information of the waiting vehicle flow according to at least one of a vehicle flow length, a vehicle type, or a vehicle flow waiting time.

Optionally, in an embodiment, the processor 420 is further configured to: after the at least one vehicle flow in the target vehicle flow set passes through the traffic intersection, select a vehicle flow from the waiting vehicle flow set according to the passing priority information and the collision relationship information, and add the selected vehicle flow to the target vehicle flow set.

Optionally, in an embodiment, a vehicle in each waiting vehicle flow in the waiting vehicle flow set is an unmanned vehicle, and the processor 420 is specifically configured to obtain the passing priority information of each waiting vehicle flow in the waiting vehicle flow set in real time according to road condition information that is obtained from a network.

It should be understood that the term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It should be understood that sequence numbers of the foregoing processes do not mean execution sequences in various embodiments of the present invention. The execution sequences of the processes should be determined according to functions and internal logic of the processes, and should not be construed as any limitation on the implementation processes of the embodiments of the present invention.

Persons of ordinary skill in the art may be aware that, the units and algorithm steps in the examples described with reference to the embodiments disclosed in this specification may be implemented by electronic hardware or a combination of computer software and electronic hardware. Whether the functions are performed by hardware or software depends on particular applications and design constraint conditions of the technical solutions. Persons skilled in the art may use different methods to implement the described functions for each particular application, but it should not be considered that the implementation goes beyond the scope of the present invention.

It may be clearly understood by persons skilled in the art that, for the purpose of convenient and brief description, for a detailed working process of the foregoing system, apparatus, and unit, reference may be made to a corresponding process in the foregoing method embodiments, and details are not described.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to actual requirements to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (ROM,), a random access memory (RAM), a magnetic disk, or an optical disc.

The foregoing descriptions are merely specific implementations of the present invention, but are not intended to limit the protection scope of the present invention. Any variation or replacement readily figured out by persons skilled in the art within the technical scope disclosed in the present invention shall fall within the protection scope of the present invention. Therefore, the protection scope of the present invention shall be subject to the protection scope of the claims.

1. A method for controlling passing of a vehicle at a traffic intersection, comprising:
obtaining passing priority information of each waiting vehicle flow in a waiting vehicle flow set in real time according to a current road condition, wherein the waiting vehicle flow is a plurality of vehicles that are waiting on a preset route to pass through the traffic intersection, and wherein the passing priority information indicates a priority of a vehicle flow in passing through the traffic intersection;
determining a waiting vehicle flow of a highest priority in the waiting vehicle flow set as a first vehicle flow according to the passing priority information;
determining a target vehicle flow set according to the first vehicle flow and prestored collision relationship information, wherein the target vehicle flow set comprises the first vehicle flow, wherein any two vehicle flows in the target vehicle flow set do not collide with each other, and wherein the collision relationship information indicates whether there is a collision when different vehicle flows simultaneously pass through the traffic intersection; and
instructing a vehicle flow in the target vehicle flow set to pass through the traffic intersection.

2. The method according to claim 1, wherein the determining a target vehicle flow set according to the first vehicle flow and prestored collision relationship information comprises:
determining at least one vehicle flow in the target vehicle flow set according to the collision relationship information and a priority of the waiting vehicle flow, wherein the at least one vehicle flow comprises a vehicle flow of a highest priority among vehicle flows that do not collide with the first vehicle flow.

3. The method according to claim 2, wherein the determining a target vehicle flow set according to the first vehicle flow and prestored collision relationship information comprises, until determining that no waiting vehicle flow that does not collide with any vehicle flow in the target vehicle flow set exists in the waiting vehicle flow set:
determining, according to the collision relationship information, whether a waiting vehicle flow that does not collide with any vehicle flow in the target vehicle flow set exists in the waiting vehicle flow set
in response to determining that the waiting vehicle flow that does not collide with any vehicle flow in the target vehicle flow set exists in the waiting vehicle flow set;
selecting a waiting vehicle flow of a highest priority from the waiting vehicle flow and
adding the selected waiting vehicle flow to the target vehicle flow set.

4. The method according to claim 1, wherein the method further comprises:
obtaining an integral table, wherein an integral in the integral table represents the passing priority information.

5. The method according to claim 1, wherein the obtaining passing priority information of each waiting vehicle flow in a waiting vehicle flow set in real time according to a current road condition comprises:
determining the passing priority information of the waiting vehicle flow according to at least one of a vehicle flow length, a vehicle type, or a vehicle flow waiting time.

6. The method according to claim 1, wherein the method further comprises:
after the vehicle flow in the target vehicle flow set passes through the traffic intersection,
selecting a vehicle flow from the waiting vehicle flow set according to the passing priority information and the collision relationship information; and
adding the selected vehicle flow to the target vehicle flow set to form a new target vehicle flow set, wherein any two vehicle flows in the new target vehicle flow set do not collide with each other.

7. The method according to claim 1, wherein a vehicle in each waiting vehicle flow in the waiting vehicle flow set is an unmanned vehicle, and wherein the obtaining passing priority information of each waiting vehicle flow in a waiting vehicle flow set in real time according to a current road condition comprises:
obtaining the passing priority information of each waiting vehicle flow in the waiting vehicle flow set in real time according to road condition information that is obtained from a network.

8. An apparatus for controlling passing of a vehicle at a traffic intersection, comprising:
at least one processor;
a non-transitory computer-readable storage medium coupled to the at least one processor and storing programming instructions for execution by the at least one processor, the programming instructions instruct the at least one processor to:
obtain passing priority information of each waiting vehicle flow in a waiting vehicle flow set in real time according to a current road condition, wherein the waiting vehicle flow is a plurality of vehicles that are waiting on a preset route to pass through the traffic intersection, and wherein the passing priority information indicates a priority of a vehicle flow in passing through the traffic intersection;
determine a waiting vehicle flow of a highest priority in the waiting vehicle flow set as a first vehicle flow according to the passing priority information;
determine a target vehicle flow set according to the first vehicle flow and prestored collision relationship information, wherein the target vehicle flow set comprises the first vehicle flow, wherein any two vehicle flows in the target vehicle flow set do not collide with each other, and wherein the collision relationship information indicates whether there is a collision when different vehicle flows simultaneously pass through the traffic intersection; and
instruct a vehicle flow in the target vehicle flow set to pass through the traffic intersection.

9. The apparatus according to claim 8, wherein the programming instructions instruct the at least one processor to determine at least one vehicle flow in the target vehicle flow set according to the collision relationship information and a priority of the waiting vehicle flow, wherein the at least one vehicle flow comprises a vehicle flow of a highest priority among vehicle flows that do not collide with the first vehicle flow.

10. The apparatus according to claim 9, wherein the programming instructions instruct the at least one processor to:
until determining that no waiting vehicle flow that does not collide with any vehicle flow in the target vehicle flow set exists in the waiting vehicle flow set,
determine, according to the collision relationship information, whether a waiting vehicle flow that does not collide with any vehicle flow in the target vehicle flow set exists in the waiting vehicle flow set
in response to determining that the waiting vehicle flow that does not collide with any vehicle flow in the target vehicle flow set exists in the waiting vehicle flow set,
select a vehicle flow of a highest priority from the waiting vehicle flow and
add the selected vehicle flow to the target vehicle flow set.

11. The apparatus according to claim 8, wherein the programming instructions instruct the at least one processor to obtain an integral table, wherein an integral in the integral table represents the passing priority information.

12. The apparatus according to claim 8, wherein the programming instructions instruct the at least one processor to obtain the passing priority information of the waiting vehicle flow according to at least one of a vehicle flow length, a vehicle type, or a vehicle flow waiting time.

13. The apparatus according to claim 8, wherein the programming instructions instruct the at least one processor
to: after the vehicle flow in the target vehicle flow set passes through the traffic intersection,
select a vehicle flow from the waiting vehicle flow set according to the passing priority information and the collision relationship information; and
add the selected vehicle flow to the target vehicle flow set.

14. The apparatus according to claim 8, wherein a vehicle in each waiting vehicle flow in the waiting vehicle flow set is an unmanned vehicle, and wherein the programming instructions instruct the at least one processor to obtain the passing priority information of each waiting vehicle flow in the waiting vehicle flow set in real time according to a current road condition that is obtained from a network.
